(19) United States
(12) Patent Application Publication
(10) Pub. No.: US 2026/0003710 A1
(43) Pub. Date: Jan. 1, 2026

(54) INTERRUPT INTEGRITY CHECK

(71) Applicant: STMicroelectronics International N.V., Geneva (CH)

(72) Inventors: Roberto Colombo, Munich (DE); Vivek Mohan Sharma, New Delhi (IN)

(21) Appl. No.: 18/754,545

(22) Filed: Jun. 26, 2024

(51) Int. Cl. G06F 11/07

(52) U.S. Cl. CPC G06F 11/0772; G06F 11/0757; G06F 11/076

(57) ABSTRACT

According to an embodiment, an interrupt checker circuit includes a timestamp checker circuit having a first input terminal coupled to an interrupt signal. A second input terminal of the timestamp checker circuit is configured to receive a global time reference. The timestamp checker circuit is configured to record a first timestamp corresponding to a first interrupt event at the first input terminal of the timestamp checker circuit based on the global time reference, record a second timestamp corresponding to a second interrupt event at the first input terminal of the timestamp checker circuit based on the global time reference, and compare a time difference between the second timestamp and the first timestamp to an expected duration and, based thereon, generate an error signal in response to the time difference being outside the expected duration.

### TECHNICAL FIELD

The present disclosure generally relates to electronic systems and, in particular embodiments, to an interrupt integrity check.

### BACKGROUND

Generally, before road vehicles can be legally operated on public roads, they must receive type approval from certain accredited organizations, known as notified bodies. This approval process verifies that the vehicle complies with a defined safety norm, ensuring functional safety from the overall system to the component and sub-component levels.

The international standard defined by the International Organization for Standardization (ISO) 26262 sets out a method tailored for the automotive sector. It defines Automotive Safety Integrity Levels (ASIL) to ascertain and manage the safety requirements necessary to reduce unreasonable risks that may persist through the lifecycle of the automotive electronic and electrical safety-related systems.

For example, automotive microcontrollers are to operate within the safety parameters established by ISO 26262. Protective measures can be integrated into these controllers' hardware or software to ensure the detection and management of potential faults. Deciding whether to opt for hardware or software solutions involves considering various factors such as the implications on physical size (area increase), hardware complexity, and software complexity. The onus falls on device suppliers to demonstrate compliance with ISO 26262 and implement and meticulously record all mandated safety precautions for effective risk mitigation.

### SUMMARY

Technical advantages are generally achieved by embodiments of this disclosure, which describe an interrupt integrity check.

A first aspect relates to an interrupt checker circuit. The interrupt checker circuit includes a timestamp checker circuit having a first input terminal coupled to an interrupt signal, a second input terminal of the timestamp checker circuit configured to receive a global time reference, the timestamp checker circuit configured to record a first timestamp corresponding to a first interrupt event at the first input terminal of the timestamp checker circuit based on the global time reference, record a second timestamp corresponding to a second interrupt event at the first input terminal of the timestamp checker circuit based on the global time reference, and compare a time difference between the second timestamp and the first timestamp to an expected duration and, based thereon, generate an error signal in response to the time difference being outside the expected duration.

A second aspect relates to interrupt checker circuit. The interrupt checker circuit includes a first timestamp checker circuit having a first input terminal coupled to a first interrupt signal, the first timestamp checker circuit configured to determine a first elapsed time between two consecutive interrupt events for the first interrupt signal and generate a first error signal in response to the first elapsed time being outside a first expected duration; and a second timestamp checker circuit having a first input terminal coupled to a second interrupt signal, the second timestamp checker circuit configured to determine a second elapsed time between two consecutive interrupt events for the second interrupt signal and generate a second error signal in response to the second elapsed time being outside a second expected duration.

A third aspect relates to a method of operating an interrupt checker circuit. The method comprising determining, by a first timestamp checker circuit of the interrupt checker circuit, a first elapsed time between two consecutive interrupt events for a first interrupt signal; determining, by a second timestamp checker circuit of the interrupt checker circuit, a second elapsed time between two consecutive interrupt events for a second interrupt signal; generating, by the first timestamp checker circuit, a first error signal in response to the first elapsed time being outside a first expected duration; and generating, by the second timestamp checker circuit, a second error signal in response to the second elapsed time being outside a second expected duration.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a block diagram of an embodiment system;

FIG. 2 is the different categories of interrupt signals in, for example, automotive applications;

FIG. 3 is a block diagram of an embodiment circuit;

FIG. 4 is a time plot for checking a single interrupt signal for errors;

FIG. 5 is a flow chart of an embodiment method;

FIG. 6 is a block diagram of an embodiment circuit;

FIG. 7 is a flowchart of an embodiment method;

FIG. 8 is an embodiment register interface;

FIG. 9 is a state diagram for a finite state machine (FSM) circuit, which may be implemented as the timestamp checker;

FIG. 10 is a state diagram for a finite state machine circuit (FSM); and

FIG. 11 is a block diagram of an embodiment circuit.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

While the inventive aspects are described primarily in the context of an interrupt signal communicated to a microcontroller in an automotive application, it should also be appreciated that these inventive aspects may also apply to microcontrollers in other consumer, commercial, or industrial applications. Further, aspects of the disclosure can apply to other types of events, such as direct memory access (DMA) triggers.

Aspects of this disclosure introduce an area-effective hardware approach that ensures adequate coverage for interrupt triggers initiated by system peripherals directed at the device controller. Thus, this approach offers a solution to enhance the functionality and safety of automotive microcontrollers without significantly increasing their size or complexity.

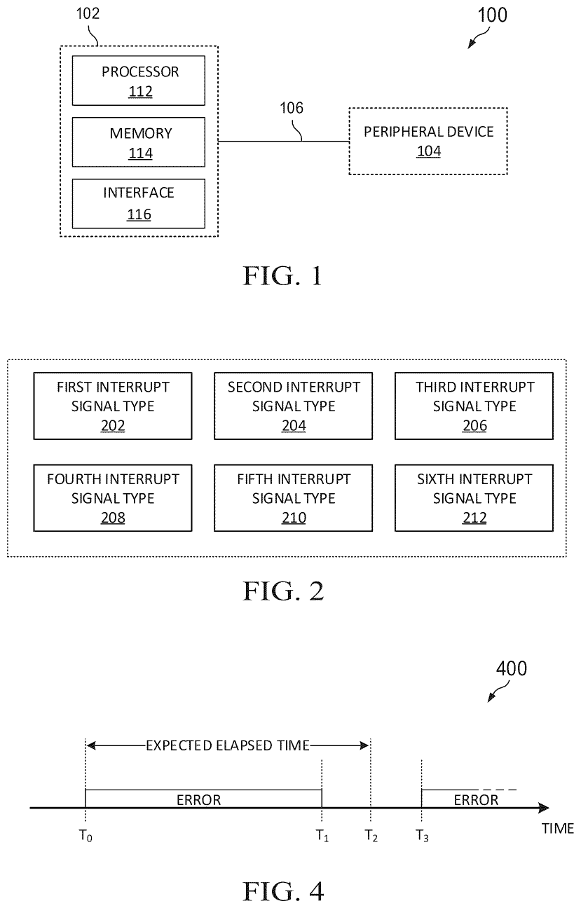

FIG. 1 illustrates a block diagram of an embodiment system 100. System 100 may be implemented as an embedded system within an automotive application or any system or sub-system that benefits from the embodiments disclosed herein.

As the automotive industry advances towards autonomous driving technology, the complexity of dedicated microcontrollers is escalating significantly. This surge in complexity is prompting innovation in various domains, such as vehicle security and safety systems. Concurrent with these developments, integrating diverse functions within a single Electronic Control Unit (ECU) necessitates more adaptable solutions. These solutions are to support various applications with different demands on the same platform.

Further, compliance with the ISO26262 safety standard requires enhancements to existing safety measures, particularly as different functions, such as braking, airbag control, and powertrain management, are amalgamated within a single microcontroller. In contemporary microcontroller design, many cores (i.e., processors) are integrated within a single device. Each core can be exposed to several interrupt triggers generated by the device's internal peripherals. Adhering to the ISO26262 safety specification, detecting any unexpected malfunctions that could occur during vehicle operation can be imperative.

System 100 includes a control unit 102 and a peripheral device 104 coupled through a data line 106, which may (or may not) be arranged as shown. System 100 may include additional components that are not shown. Although FIG. 1 shows a single number of the peripheral device 104, in embodiments, a control unit 102 may be coupled to many peripheral devices, such as the peripheral device 104, through multiple data lines, such as data line 106.

The control unit 102 includes a processor 112, a memory 114, and an interface 116, which may (or may not) be arranged as shown. The control unit 102 may include additional components not shown, such as power control units, security and encryption modules, or the like. In embodiments, the control unit 102 is a vehicle's Electronic Control Unit (ECU).

Processor 112 may be any component or collection of components adapted to perform computations or other processing-related tasks. In embodiments, processor 112 is a microcontroller, a signal processor, a microprocessor-controlled signal processor, a system-on-chip (SoC), an application-specific integrated circuit (ASIC), a field-programmable gate array (FPGA), or the like. Processor 112 may include multiple processing cores. In embodiments, each processing core may be responsible for specific applications. In embodiments, the many cores operate in parallel to execute certain functions. In embodiments, each processing core of processor 112 has a dedicated real-time operating system. In embodiments, processor 112 is embedded within the vehicle's ECU.

Memory 114 may be any component or collection of components adapted to store programming, instructions, or data for storage or execution by processor 112. In an embodiment, memory 114 includes a non-transitory computer-readable medium. In embodiments, memory 114 is configured to store the real-time operating systems for the various processing cores of processor 112. Each real-time operating system can schedule different activities or tasks within system 100.

Interface 116 may be any component or collection of components that allows internal communication within the control unit 102 or external communication with components of system 100.

In embodiments, peripheral device 104 can be a sensor, an actuator, a vehicle module, or an interface within an automotive application. The sensor can be, for example, an oxygen sensor, a throttle position sensor (TPS), a wheel speed sensor, a crankshaft position sensor, a camshaft position sensor, or a temperature sensor. The actuator can be, for example, a fuel injector, an ignition coil, a variable valve timing (VVT) solenoid, a throttle actuator, or an electronic stability program (ESP) actuator. The vehicle module can be, for example, a body control module (BCM), a transmission control module (TCM), or an airbag control module. The interface can be, for example, an infotainment system or a heating, ventilation, and air conditioning (HVAC) control.

In embodiments, the data line 106 enables data transfer between the control unit 102 and the peripheral device 104. In an exemplary automotive application, data line 106 facilitates the exchange of information between the ECU and various peripheral devices, such as sensors and actuators. The data line 106 can be structured as part of the vehicle's wiring harness. It can operate based on established communication protocols, such as controller area network (CAN), local interconnect network (LIN), FlexRay, or Media Oriented Systems Transport (MOST), among others, depending on the specific application and bandwidth requirements.

Potential causes for malfunctions within processor 112 may stem from various factors, such as the natural aging process of processor 112, exposure to alpha radiation from the environment, failure of transistors, or random bit flips. These issues can lead to unpredictable behavior and errors in its operation. An internal watchdog mechanism can be used to monitor the core functionality of processor 112 and safeguard against such irregularities. This internal monitor can detect a fault if something goes awry, such as an anomalous spike in the clock frequency beyond its normal operational range. Upon recognizing the error, the monitor relays this information to a fault collector system. The fault collector then intervenes by deploying a predetermined response to mitigate the issue. Its goal is to transition the processor 112 back to a stable and safe state, thus preventing further complications and maintaining the integrity of the system's performance.

Processor 112 is configured to execute software applications capable of performing diverse functions within system 100. The software applications typically operate on a real-time operating system (RTOS), orchestrating various activities by processor 112 according to a specific schedule. Generally, tasks are allocated time to carry out certain operations, which may, in turn, trigger other tasks to commence their designated actions. Ordinarily, activities are arranged based on a timer mechanism that equitably distributes processing time among tasks. In addition to this timed scheduling, the system handles asynchronous events; an external interrupt can initiate a task, such as retrieving and processing data, a processing core may initiate a communication with another processing core, or the like. Maintaining strict adherence to deadlines is essential in a real-time system, as failing to perform a required action within the designated timeframe can result in safety issues.

An illustrative example of such a critical deadline is in automotive systems, where precise timing of fuel injection is crucial. For example, suppose the peripheral device 104 is an oxygen sensor. In that case, if the oxygen sensor detects a deviation in the exhaust gas composition, it sends an interrupt signal to a processing core of processor 112 of control unit 102 via data line 106 and interface 116 to adjust the air-fuel mixture. If the fuel delivery is not synchronized with the appropriate position of the piston—for example, injecting fuel when the piston is not in the correct position—then the fuel may be wasted, leading to potential engine problems. In response to receiving the interrupt signal, the processing core of processor 112, responsible for the fuel delivery within the vehicle, can temporarily halt its current operation and process the interrupt through, for example, an interrupt service routine (ISR) designed to handle the interrupt's requirements. The interrupt service routine executed by the processing core can read data from the peripheral device 104 through data line 106 to understand the nature of the event. Based on the data, control unit 102 can perform necessary actions, such as adjusting engine parameters, activating actuators, or storing diagnostic information. After the processing core handles the interrupt, it completes the interrupt service routine and resumes its previous operations.

Accordingly, the real-time operating systems of the processing cores monitor operations within system 100 to ensure each task is completed within specified time constraints. However, this level of supervision can become highly complex. With each processing core of processor 112 having to contend with numerous interrupt signals and oversee hundreds of different tasks, the challenge lies in crafting software capable of managing and verifying that all system components function accurately within the established timing parameters.

Under the ISO26262 safety standards, detecting unexpected malfunctions of each peripheral device 104 during operation becomes essential, as they pose risks to vehicle functionality and occupant safety. This task can become unfeasible for software monitoring solutions due to the sheer volume of concurrent demands, which can significantly complicate the software architecture. In embodiments, a hardware solution is proposed that alleviates tasks conventionally performed by software monitoring solutions.

FIG. 2 illustrates the different categories of interrupt signals in, for example, automotive applications. Interrupt signals, which may be synchronous or asynchronous, act as stimuli that prompt specific functions aimed at performing targeted operations. Synchronous interrupts are characterized by their periodic nature; they are expected at predefined intervals (i.e., certain periodicity). For example, any deviation from the expected schedule prompted by the interrupt, whether missed or occurring too early or too late, can have significant implications for the system's behavior.

As another example, a periodic interrupt may be set to process data received from a peripheral device 104, such as a sensor configured to measure vehicle speed or inputs from vehicle radar and cameras. As synchronous interrupts are triggered at a consistent pace, processing of these data can be critical so that any signs of an unusual condition can be identified and addressed promptly, ensuring hazards are mitigated effectively.

Asynchronous interrupts are driven by events that don't follow a regular pattern. While they are inherently unpredictable, this doesn't preclude the possibility of their occurrence during the device's lifespan—they may still be expected sporadically without a fixed schedule. Asynchronous interrupts can be further categorized into predicted asynchronous interrupts, such as an acknowledgment signal received following a sent message, and unpredicted asynchronous interrupts, like unexpected events that occur without warning.

In embodiments where the control unit 102 is coupled to many different peripheral devices, each peripheral device 104 can generate an interrupt signal at any time. Further, numerous microtasks employ interrupt signals triggered by specific IP upon completion of an action, with the expectation that the associated processing core will respond to the interrupt and process the corresponding data.

For example, in the case of Ethernet transmission, when data is received via the Internet, the IP signals the associated processing core with an interrupt signal, indicating that the data has arrived and is prepared for processing by the associated processing core. The associated processing core is then expected to take action in response to receiving the interrupt signal and retrieving and handling the incoming data as it arrives.

Both types of interrupts (i.e., asynchronous and synchronous) are vital in automotive systems, where they play a crucial role in maintaining overall system performance and ensuring safety measures are triggered as required. More generally, the interrupt signals in automotive systems can be categorized into six types. Given the variety of interrupt signal types and the high number of interrupt signals, monitoring periodic interrupt signals can become extremely complex for software-based safety mechanisms.

A first interrupt signal type 202 is a synchronous interrupt signal characterized by its expected periodicity; it is anticipated to be asserted continuously at consistent, regular intervals. The approach to safety for this interrupt type does not involve duplication of the interrupt signal. Instead, the protection mechanism (i.e., interrupt checker) evaluates the time between sequential occurrences on the same interrupt signal.

The time between the sequential interrupt signal occurrences is compared to a minimum, maximum, or window threshold. If the time measured is outside the interrupt signal's defined parameters, an error signal can be generated, indicating a fault.

A second interrupt signal type 204 is a duplicated synchronous interrupt signal. Like the first interrupt signal type 202, the second interrupt signal type 204 has an expected periodicity and is asserted at uniformly regular intervals. However, in contrast to the first interrupt signal type 202, the safety mechanism implemented for the second interrupt signal type 204 is twofold, incorporating a redundancy where the interrupt signal is duplicated through, for example, independent hardware components. The interrupt checker protection performs two critical evaluations. Firstly, similar to the first interrupt type, it measures the time elapsed between consecutive events on the same interrupt signal to ensure consistency in periodicity. Secondly, it assesses the time difference, or skew, between the occurrences of the interrupt events in the duplicated safety mechanisms.

The time between the sequential interrupt signal occurrences is compared to a minimum, maximum, or window threshold. If the time measured is outside the interrupt signal's defined parameters, an error signal can be generated, indicating a fault.

The time difference (i.e., skew) between the occurrences of the interrupt events in the duplicated safety mechanisms is compared against a minimum, maximum, or window threshold. If the time difference is outside the defined parameters for the interrupt signal, an error signal can be generated, indicating a fault.

For example, the second interrupt signal type 204 might apply to a communication channel, where data is transmitted along a conduit like a wire. To mitigate potential errors, one might duplicate this channel with two separate physical wires, establishing a parallel path as a precautionary measure. In this context, evaluations are made on the timing of consecutive interrupts within each path and the skew—the temporal discrepancy—between the paired interrupt signals. The expectation is that these interrupt signals, though slightly staggered, should carry identical information and be checked to confirm they arrive within a predetermined acceptable time threshold.

A third interrupt signal type 206 is an asynchronous signal anticipated to occur following the execution of a specific function. Like the first interrupt signal type 202, it does not employ a redundancy approach and functions without a duplicated interrupt signal. The interrupt checker protection mechanism measures the interval between the designated function's completion and the interrupt trigger's assertion.

The specific function is executed properly if the measured interval between the designated function's completion and the interrupt trigger's assertion is within a maximum acceptable threshold time. Otherwise, if the interval exceeds the maximum acceptable threshold time, the specific function is deemed to have failed the execution.

For example, after programming a Virtual Machine (VM), an asynchronous interrupt signal of the third interrupt signal type 206 may be used to indicate the completion of the programming task. Should this interrupt signal fail to arrive as expected, the system triggers a flag indicating an error. This flag alerts that the programming sequence was not completed successfully or there is a communication issue.

A fourth interrupt signal type 208, similar to the third interrupt signal type 206, is an asynchronous signal anticipated to occur following the execution of a specific function. Similar to the second interrupt signal type 204, it employs a redundancy approach where the interrupt signal is duplicated. The interrupt checker protection performs two critical evaluations. Firstly, similar to the third interrupt signal type 206, it measures the interval between the completion of the designated function and the assertion of the interrupt trigger. Secondly, similar to the second interrupt signal type 204, it assesses the time difference, or skew, between the occurrences of the interrupt events in the duplicated safety mechanisms.

The specific function is executed properly if the measured interval between the designated function's completion and the interrupt trigger's assertion is within a maximum acceptable threshold time. Otherwise, if the interval exceeds the maximum acceptable threshold time, the specific function is deemed to have failed the execution.

The time difference (i.e., skew) between the occurrences of the interrupt events in the duplicated safety mechanisms is compared against a minimum, maximum, or window threshold. If the time difference is outside the defined parameters for the interrupt signal, an error signal can be generated, indicating a fault.

A fifth interrupt signal type 210 is an unexpected asynchronous signal. Similar to the first interrupt signal type 202 and the third interrupt signal type 206, it does not employ a redundancy approach and functions without the duplicated interrupt signal. The interrupt checker protection mechanism is performed in software based on the arrival of the interrupt signal without any assumption on the arrival time.

Finally, a sixth interrupt signal type 212 is an unexpected asynchronous signal, similar to the fifth interrupt signal type 210. It employs a redundancy approach with a duplicated interrupt signal like the second interrupt signal type 204 and the fourth interrupt signal type 208. Firstly, the interrupt checker protection mechanism is performed in software based on the arrival of the interrupt signal without any assumption on the arrival time. Secondly, similar to the second interrupt signal type 204 and the fourth interrupt signal type 208, the protection mechanisms assess the time difference, or skew, between interrupt events in the duplicated safety mechanism.

The time difference (i.e., skew) between the occurrences of the interrupt events in the duplicated safety mechanisms is compared against a minimum, maximum, or window threshold. If the time difference is outside the defined parameters for the interrupt signal, an error signal can be generated, indicating a fault.

The second interrupt signal type 204, the fourth interrupt signal type 208, and the sixth interrupt signal type 212 include a duplicated interrupt signal, typically implemented within applications requiring additional safety measures (i.e., safety-critical interrupts). For these cases, the interrupt signal is duplicated through, for example, two separate trigger mechanisms. The functionality of the initial interrupt signal is duplicated by a plausibility check through the interrupt checker protection mechanism. In contrast, the first interrupt signal type 202, the third interrupt signal type 206, and the fifth interrupt signal type 210 are typically associated with non-safety critical interrupt types and include a single interrupt signal (i.e., a single trigger).

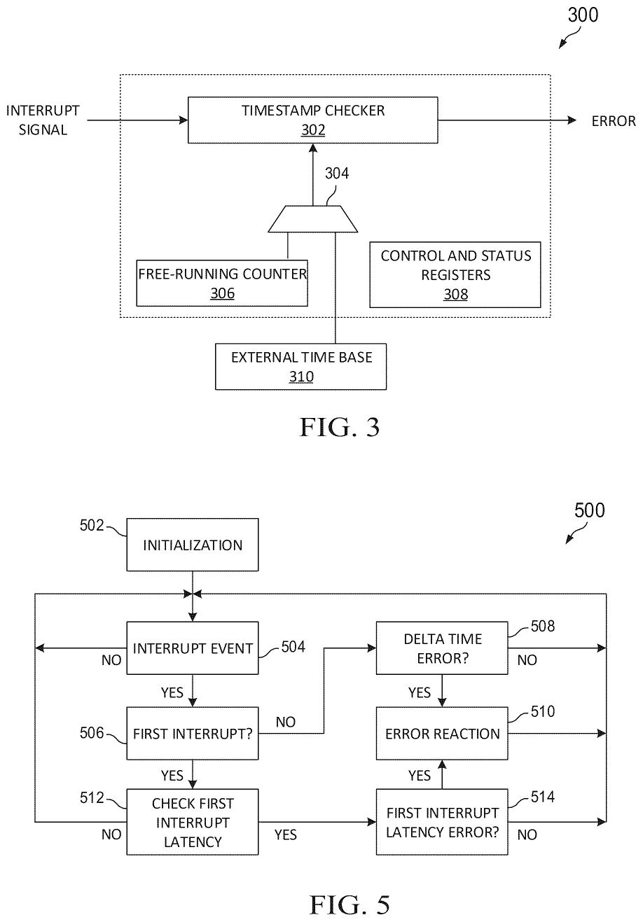

FIG. 3 illustrates a block diagram of an embodiment circuit 300. Circuit 300 includes a timestamp checker 302, a multiplexer 304, a free-running counter 306, and control and status registers 308, which may (or may not) be arranged as shown. Circuit 300 may be coupled to an external time base 310, generated by an external component to circuit 300. Circuit 300 may include additional components not shown.

Circuit 300 is a hardware solution for monitoring an elapsed time for a device interrupt. In embodiments, circuit 300 verifies the occurrence of an interrupt event within an adjustable, set time frame.

In embodiments, timestamp checker 302 is a finite state machine (FSM) circuit. The timestamp checker 302 includes a first input terminal configured to receive an interrupt trigger based on one of the first interrupt signal type 202 or the third interrupt signal type 206.

In embodiments, the control and status registers 308 include programmable registers. The programmable registers can store threshold definitions for the interrupt signals. In embodiments, the programmable registers store definitions indicating the start of an interrupt check by circuit 300.

For example, the programmable registers may store the minimum, maximum, or window thresholds for (1) the time difference between the sequential interrupt signal occurrences (for periodic interrupt types) and (2) the maximum acceptable threshold time between a designated function's completion and the interrupt trigger's assertion (for non-periodic interrupt types).

In embodiments, the control and status registers 308 include control registers. The control registers can be used to set and configure the various components of circuit 300. For example, the control registers can provide a select signal to multiplexer 304 to select between the free-running counter 306 or the external time base 310 based on, for example, the particular interrupt that is being monitored or the application.

In embodiments, the control and programmable registers of the control and status registers 308 are software accessible and can be programmed, configured, or modified based on the application to control the operation of circuit 300.

Free-running counter 306 is configured to generate an internal time reference for circuit 300. In embodiments, the duration of the time reference, internally generated by the free-running counter 306, is sufficiently large to span the entire trip time as specified by the ISO26262 standard for vehicle safety, which is 12 hours. In embodiments, free-running counter 306 operates with a safe clock whose frequency is typically guaranteed—as it is commonly utilized in safety—related integrated circuits—and not excessively high.

For example, if the safe clock operates at a frequency of 40 MHz, free-running counter 306 can count up to 12 hours, considering a single clock period of 25 nanoseconds. A 41-bit timer would suffice for this requirement. However, a less extensive timer may be adequate since the precision necessary for aligning the timer with the anticipated interrupts does not usually demand a single-clock-period resolution. By way of illustration, a 37-bit timer could be utilized, where the four least significant bits (LSBs) are truncated from the 41-bit timer, resulting in a timestamp with a resolution of 0.4 microseconds. The free-running counter 306 can include a configurable parameter to set the actual size of the timer, allowing for optimization of the area relative to the required interrupt period.

Alternatively, circuit 300 may receive an absolute time reference from an external time base 310 provided by another circuit external to circuit 300. The external circuit may be a circuit component within a microcontroller with, for example, a 64-bit timer, which continually increases during the lifetime of the device hosting the circuit 300.

The multiplexer 304 may select between the absolute time reference from the external time base 310 or the internal time reference from the free-running counter 306. In embodiments, the multiplexer 304 is optional. In embodiments, circuit 300 includes the free-running counter 306 without the externally generated absolute time reference. In embodiments, circuit 300 includes a pad and traces to receive the externally generated absolute time reference without the free-running counter 306.

A second input terminal of the timestamp checker 302 receives the time reference from either the absolute time reference, generated externally by external time base 310, or the internal time reference generated by the free-running counter 306.

After activation of the timestamp checker 302, the timestamp at the initial instance of the interrupt trigger's activation is recorded. Subsequently, if the same interrupt is activated again, the timestamp checker 302 proceeds to calculate the time elapsed since the prior timestamp was logged.

Timestamp checker 302 ascertains whether the duration between the sequential interrupt signal occurrences falls within a predefined interval, which may be stored in the programmable registers of the control and status registers 308. If the elapsed time meets the expected criteria, the latest timestamp replaces the old one, which is recorded in, for example, the control and status registers 308. This process ensures that circuit 300 continuously monitors and validates the timing of interrupt events.

In embodiments, the programmable registers of the control and status registers 308 include tolerance level registers for setting a programmable tolerance level during interrupt checks. Tolerance level registers permit the specification of an allowable margin of time between the anticipated interrupt time and the actual occurrence of the interrupt. For instance, if the programmed duration for the expected interrupt is E and the set tolerance is T, an interrupt will be confirmed as timely if it occurs within the time bracket of (E±ΔT). Although incorporating tolerance settings per interrupt or paired interrupts may increase area requirements, it allows for enhanced precision in timing validation.

Interrupt monitoring by circuit 300 can be continuous or controlled, depending on a configurable setting provided by, for example, a control register of the control and status registers 308. Each interrupt can be assigned a configuration bit that determines whether the check should be ongoing or activated only when armed. Restricting checks to armed status offers the flexibility to discontinue monitoring when periodic interrupts are deliberately halted for any reason. It then becomes the software's responsibility to arm the circuit 300 within the interrupt service routine when monitoring is not continuous. On the other hand, a constant check can be ideal for monitoring critical interrupt triggers that are expected never to cease.

When a discrepancy is detected with an interrupt trigger, such as being too early, too late, or altogether missing, an error signal (i.e., flag) is generated by timestamp checker 302. A specific status register within the programmable registers of the control and status registers 308 can be allocated to identify which interrupt has encountered an issue. Additionally, another status register within the programmable registers of the control and status registers 308 can be tasked with indicating whether the deviation involves the interrupt arriving too prematurely or excessively delayed. These diagnostic features can aid in troubleshooting and maintaining system integrity. Accordingly, circuit 300 provides a hardware solution for detecting errors associated with interrupt signals of the first interrupt signal type 202 or the third interrupt signal type 206.

Circuit 300 can be extended to include multiple instances of timestamp checker 302. Each additional timestamp checker may be configured independently to monitor a different interrupt signal, whether asynchronous or synchronous. The operation of the additional timestamp checkers is similar to that described concerning timestamp checker 302.

FIG. 4 illustrates a time plot 400 for checking a single interrupt signal for errors by circuit 300. Circuit 300 evaluates whether, for a periodic interrupt signal, a second interrupt signal arrives within a certain expected time or whether, for an asynchronous one-shot interrupt, an event occurs within a maximum time threshold.

At time T₀, an interrupt event is triggered. The interrupt event can indicate the start of a first (i) interrupt trigger (i being an integer greater than or equal to 1) of a periodic interrupt signal or an initialization time for an asynchronous one-shot interrupt signal.

For a periodic interrupt signal, assuming that the first (i) interrupt trigger occurs at time T₀, the second (i+1) interrupt trigger would ideally arrive at time T₂, with an expected elapsed time equaling T₂−T₀. As previously discussed, a programmable tolerance value (ΔT) may be associated with the arrival time of the second interrupt trigger (i+1). The tolerance value (ΔT) may then allow a time window between T₁ and T₃ for which the arrival of the second (i+1) interrupt trigger would be deemed timely. However, if the second (i+1) interrupt trigger arrives between times T₀ and T₁, the interrupt trigger is too early, and an error signal is generated by timestamp checker 302. Further, if the second (i+1) interrupt trigger arrives after time T₃, the interrupt trigger is too late, and an error signal is generated by timestamp checker 302. Finally, if the second (i+1) interrupt trigger does not arrive after a threshold duration, the interrupt trigger is missing, and an error signal is generated by timestamp checker 302.

For a non-periodic interrupt signal, assuming that the initialization time for an asynchronous one-shot interrupt signal occurs at time T₀, the associated interrupt trigger would ideally arrive at time T₂, with an expected elapsed time equaling T₂−T₀. As previously discussed, a tolerance value may be associated with the arrival time of the interrupt trigger. The tolerance value may then allow a time window between T₁ and T₃ for which the arrival of the interrupt trigger would be deemed as timely. However, if the interrupt trigger arrives between times T₀ and T₁, the interrupt trigger is too early and an error signal is generated by timestamp checker 302. Further, if the interrupt trigger arrives after time T₃, the interrupt trigger is too late and an error signal is generated by timestamp checker 302. Finally, if the interrupt trigger does not arrive after a threshold duration, the interrupt trigger is missing and an error signal is generated by timestamp checker 302.

FIG. 5 illustrates a flow chart of an embodiment method 500 for operating circuit 300. Method 500 can check an elapsed time between two consecutive interrupt events for a synchronous interrupt signal. Method 500 can check an elapsed time between activating a function and an associated interrupt signal for an asynchronous interrupt signal. It is noted that all steps outlined in the flow chart of the method are not necessarily required and can be optional. Further, changes to the arrangement of the steps, removal of one or more steps and path connections, and addition of steps and path connections are similarly contemplated.

At step 502, circuit 300 is initialized to check a single interrupt signal for errors. In embodiments, the initialization includes loading configuration and threshold definitions from program registers and control registers of the control and status registers 308 to components of circuit 300.

In embodiments, the initialization includes resetting registers designated to store the timestamp values for the interrupt events to zero, for example. In embodiments, a reset signal is used to reset the timestamp checker 302, and various registers of the control and status registers 308. The initialization may also include resetting latches associated with the timestamp checker 302.

In embodiments, circuit 300 can include a programmable register flag. During the initialization process, the programmable register flag is set based on the interrupt signal to be monitored. The interrupt signal can be identified by the timestamp checker 302 as being a synchronous or an asynchronous interrupt signal by the value stored in the programmable register flag. For example, the value of the programmable register flag can be set to zero for a synchronous interrupt signal and set to one for an asynchronous interrupt signal.

At step 504, the timestamp checker 302 monitors the first terminal for an interrupt event. The monitoring of the first terminal may be continuous or controlled. If no event is detected (i.e., triggered), the timestamp checker 302 repeats step 504. If an interrupt event is detected, the method turns to step 506. In embodiments, an interrupt timestamp is stored onto a first interrupt buffer in response to detecting the interrupt event by the timestamp checker 302. A first interrupt latch transitions from a zero to a one, indicating that the first interrupt event has occurred.

For example, the first interrupt latch is reset to zero after the initialization at step

502; therefore, upon detecting an interrupt event and verifying that the first interrupt latch is zero, the interrupt timestamp is stored onto the first interrupt buffer and the first interrupt latch is set to one.

At step 506, in response to detecting an interrupt event, the timestamp checker 302 checks whether the interrupt event is a first interrupt event after initializing the circuit 300 by checking the first interrupt latch. If the interrupt event (i.e., for an asynchronous interrupt signal) is not the first after initializing the circuit 300, the method turns to step 508. Otherwise, if the interrupt event is the first after initiating the circuit 300, the method transitions to step 512.

In embodiments, the operation of the timestamp checker 302 is configured with two interrupt latches—the first interrupt latch and a second interrupt latch. When an interrupt event occurs, if it is the initial event for the interrupt signal, its timestamp is captured and stored in the first interrupt buffer. If it is not the first interrupt event, the interrupt timestamp is stored in the second interrupt buffer instead. A mechanism can be used to prevent storing the interrupt timestamp more than once consecutively in the same buffer. For example, after the interrupt timestamp is stored in a buffer, the latch signal that controls which buffer the timestamp goes into can be inverted. This inversion can ensure that the next timestamp will be directed to the opposite buffer, effectively alternating the storage location for each new interrupt event.

For a synchronous (i.e., periodic) interrupt signal, at step 512, the latency of the first interrupt signal is not checked. As the interrupt event is the first one after initializing circuit 300, the timestamp of the arrival of the first interrupt signal is stored in a register. The method returns to step 504 to monitor the subsequent interrupt event for the synchronous interrupt signal.

For an asynchronous (i.e., non-periodic) interrupt signal, the latency of the first interrupt signal needs to be checked. Consider an activated function, where a timestamp associated with the activation of the function is stored in a register. Upon activation of the function and the arming (i.e., initialization) of the timestamp checker, the timestamp corresponding to the moment the function is activated is stored in the first interrupt buffer, and the first interrupt latch is asserted. The method transitions to step 514.

After the activation of the function, an interrupt event occurs with some latency. At step 514, for an asynchronous (i.e., non-periodic) interrupt signal, the latency for the interrupt event for the recently activated function is checked. To measure the latency, the timestamp for the arrival of the interrupt event is subtracted from the timestamp corresponding to the moment the function is activated. If the latency is outside a threshold value, the interrupt signal is deemed untimely, and the method transitions to step 510. However, the asynchronous interrupt signal is deemed timely if the calculated latency is within the threshold value. In embodiments, the timestamp for the arrival of the interrupt event is stored in the first interrupt buffer, and the method returns to step 504 to monitor the subsequent interrupt event for the asynchronous interrupt signal. In embodiments, the check for the asynchronous interrupt signal ends after the completion of step 514, and the timestamp checker 302 for the asynchronous interrupt signal to be monitored is disarmed. The timestamp difference calculation by timestamp checker 302 for the asynchronous interrupt can be activated on demand and deactivated, for example, when the application completes a specific function necessitating an interrupt reception.

For asynchronous interrupts, the tolerated range for timestamp differences can be set more generously than for synchronous interrupts, allowing for the expectation of interrupt events to be mapped across a wider temporal spectrum. In an embodiment, the threshold value may be stored in a register.

For example, consider an inter-processor communication scenario: an interrupt generation request may be issued following a response from the target processor to the inter-processor request. The programmable register flag is set at step 502 to indicate the asynchronous interrupt signal type. When the timestamp checker 302 is initialized and set to armed status, the current timestamp is immediately stored in the first interrupt buffer and the first interrupt latch is asserted. Upon the assertion of the interrupt, timestamp checker 302 captures the timestamp into the second interrupt buffer, and the timestamp comparison between the two timestamps and the threshold is completed. This mechanism verifies whether the asynchronous interrupt signal is received within a predefined and programmable latency following the arming of the timestamp checker 302. After an interrupt event has been acknowledged, the timestamp checker 302 can be deactivated (i.e., disabled) to prevent further automatic comparisons from being executed.

At step 508, for a synchronous (i.e., periodic) interrupt signal, at step 508, timestamp checker 302 compares the timestamp of a previous interrupt event stored in the first interrupt buffer to the timestamp of the arrival of the current interrupt event stored in the second interrupt buffer. Suppose the current interrupt event arrives within the programmable tolerance value of the expected elapsed time. In that case, the interrupt event is deemed timely, the timestamp value in the first interrupt buffer is updated with the value of the current timestamp stored in the second interrupt buffer, and the method returns to step 504 to monitor the subsequent interrupt event for the synchronous interrupt signal. However, if the current interrupt event arrives outside the programmable tolerance value of the expected elapsed time, the interrupt event is deemed untimely, and the method turns to step 510. In embodiments, the threshold values used to determine the timeliness of the interrupt event are stored in registers.

In embodiments, the timestamp comparison at step 508 for a synchronous interrupt signal is performed immediately after at least two timestamps have been stored in the buffers (i.e. when the second timestamp buffer has a non-zero value).

Generally, for synchronous interrupts, the threshold value that the timestamp difference is compared to is sufficiently small (e.g., sufficient to detect jitter variations) to enable the detection of any discrepancies that may compromise the operation linked with the interrupt events. For example, a streaming communication application relies on consistently timed and periodic interrupts. The difference between timestamps is adjusted to align with the expected rate of interrupts, incorporating a margin of tolerance that reflects reasonable fluctuation. Further, as synchronous interrupts occur at regular intervals, once enabled, they continue to assert repeatedly as long as the corresponding function remains in operation.

In embodiments, the timestamp checker 302 performs the timestamp comparison at step 508 or 514 by assessing the difference between two captured timestamps by employing a modulo operation. This approach ensures that the relative magnitude of the values in the first and second interrupt buffers is inconsequential—whether one is greater or smaller does not affect the evaluation outcome. If, for example, the computed difference between the timestamps exceeds or falls short of a predefined threshold set in a register allocated for each respective interrupt, the method transitions to step 510. Additionally, for each interrupt, a user-programmable tolerance level can be established. This tolerance parameter can define acceptable boundaries for variations in the timing of interrupts, providing flexibility and precision in error detection and system response activities.

At step 510, in response to an untimely interrupt signal, as determined in, for example, steps 508 or 514, the timestamp checker 302 generates an error signal indicating a fault with the interrupt signal. In embodiments, the method remains at step 510 until the interrupt comparison is disabled for the interrupt signal.

It should be noted that timestamp checker 302, for a synchronous interrupt signal, can initially perform a first timestamp comparison similar to an asynchronous interrupt signal comparison (i.e., comparing a timestamp difference between the activation of a function and the arrival of an associated interrupt) and then transition to comparing consecutive interrupt signals for subsequent periodic events.

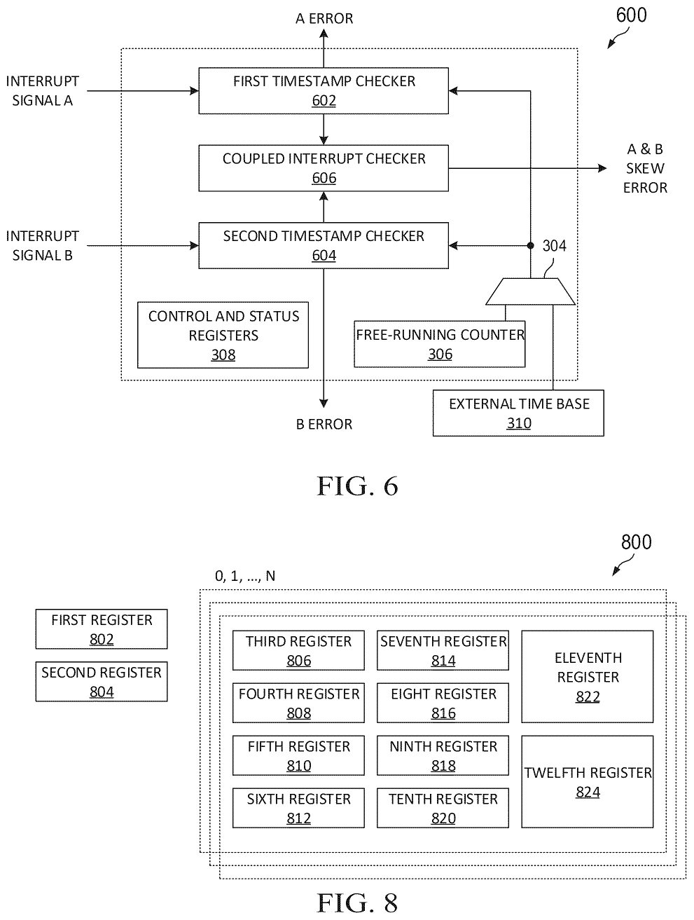

FIG. 6 illustrates a block diagram of an embodiment circuit 600. Circuit 600 includes a first timestamp checker 602, a second timestamp checker 604, a coupled interrupt checker 606, the multiplexer 304, the free-running counter 306, and the control and status registers 308, which may (or may not) be arranged as shown. Circuit 600 may be coupled to the external time base 310. The structure and function of components previously discussed concerning the circuit 300 are not repeated for brevity.

Circuit 600 is a hardware solution for monitoring the elapsed time of a device interrupt (similar to circuit 300). It can be extended to monitor a time difference (i.e., skew) between the arrival of pairs of interrupts in a duplicated interrupt signal architecture, such as in the second interrupt signal type 204, the fourth interrupt signal type 208, and the sixth interrupt signal type 212. In embodiments, circuit 600 verifies the occurrence of interrupt events within an adjustable, set time frame.

Each of the first timestamp checker 602 and the second timestamp checker 604 includes a first input terminal configured to receive a respective interrupt trigger. In embodiments, the first timestamp checker 602, the second timestamp checker 604, and the coupled interrupt checker 606 are finite state machine (FSM) circuits.

When the interrupt signals at the first timestamp checker 602 and the second timestamp checker 604 are of the first interrupt signal type 202 or the third interrupt signal type 206, the first timestamp checker 602 and the second timestamp checker 604 react similarly to the timestamp checker 302 of circuit 300 and the coupled interrupt checker 606 is not activated. In embodiments, a register is set within the control and status registers 308 to decouple the first timestamp checker 602 and the second timestamp checker 604, which operate similarly to timestamp checker 302.

When the interrupt signals at the first timestamp checker 602 and the second timestamp checker 604 are of the second interrupt signal type 204, the fourth interrupt signal type 208, or the sixth interrupt signal type 212, the first timestamp checker 602 and the second timestamp checker 604 react similarly to the timestamp checker 302 of circuit 300—the first interrupt signal and the second interrupt signal are interrupt signals of a duplicated safety mechanism. However, the coupled interrupt checker 606 is also activated in this instance. Coupled interrupt checker 606 receives the trigger events from each of the first timestamp checker 602 and the second timestamp checker 604 and performs a check on the first and second interrupt signals.

In embodiments, circuit 600 can include a programmable register flag. During the initialization process, the programmable register flag can be set based on the interrupt signal to be monitored. The interrupt signal can be identified by the first timestamp checker 602 and the second timestamp checker 604 as being a synchronous interrupt signal, an asynchronous interrupt signal, a duplicated synchronous interrupt signal, or a duplicated asynchronous interrupt signal by the value stored in the programmable register flag.

Linking two interrupt signals at the input of the circuit 600 can be performed in various ways. For example, the value of the programmable register flag can be set to “00” for a synchronous interrupt signal, set to “01” for an asynchronous interrupt signal, set to “10” for a duplicated synchronous interrupt signal, and “11” for a duplicated asynchronous interrupt signal. In embodiments, separate register flags may indicate whether (i) the interrupt signal is synchronous or asynchronous and (ii) the interrupt signal is duplicated at the pair of timestamp checkers of circuit 600.

In embodiments, a comparison register within the control and status registers 308 can be set to couple (i.e., link) the first timestamp checker 602 and the second timestamp checker 604 to check the skew of the two interrupt signals by the coupled interrupt checker 606.

In embodiments, an additional multiplexer may be added to circuit 600 to link or de-link the input signals at the first timestamp checker 602 and the second timestamp checker 604.

Accordingly, circuit 600 may operate similarly to circuit 300 by setting the appropriate register(s) and identifying whether to monitor two independent interrupt signals or to have the additional feature of comparing the skew between duplicate interrupt signals.

In embodiments, each of the first timestamp checker 602 and the second timestamp checker 604 is configured to check an elapsed time between (i) two consecutive interrupt events for a synchronous interrupt signal, (ii) activating a function and an associated interrupt signal for an asynchronous interrupt signal, or both, regardless of whether the two interrupt signals are linked or de-linked.

In embodiments, the time difference (i.e., skew) between the first interrupt signal event and the second interrupt signal interrupt event is compared against a minimum, maximum, or window threshold. If the time difference is outside the defined parameters for the interrupt signal, the coupled interrupt checker 606 generates an error signal, indicating a fault.

In embodiments, the programmable registers store the minimum, maximum, or window threshold for the time difference (i.e., skew) between the occurrences of the pair of interrupt events in the duplicated safety mechanisms.

The control registers of the control and status registers 308 can be used to set and configure the various components of circuit 600.

Interrupt monitoring by circuit 600 can be continuous or controlled, depending on a configurable setting provided by, for example, a control register of the control and status registers 308. Each interrupt, or pair of interrupts, can be assigned a configuration bit that determines whether the check should be ongoing or activated only when armed. Restricting checks to armed status offers the flexibility to discontinue monitoring when periodic interrupts are deliberately halted for any reason. It then becomes the software's responsibility to arm the circuit 600 within the interrupt service routine when monitoring is not continuous. On the other hand, a constant check is ideal for monitoring critical interrupt triggers that are expected never to cease.

Circuit 600 can be extended to include multiple instances of the first timestamp checker 602, the second timestamp checker 604, and the coupled interrupt checker 606. Each additional instance may be configured independently to monitor a different interrupt signal, whether asynchronous or synchronous. The operation of the additional timestamp checkers is similar to that previously described.

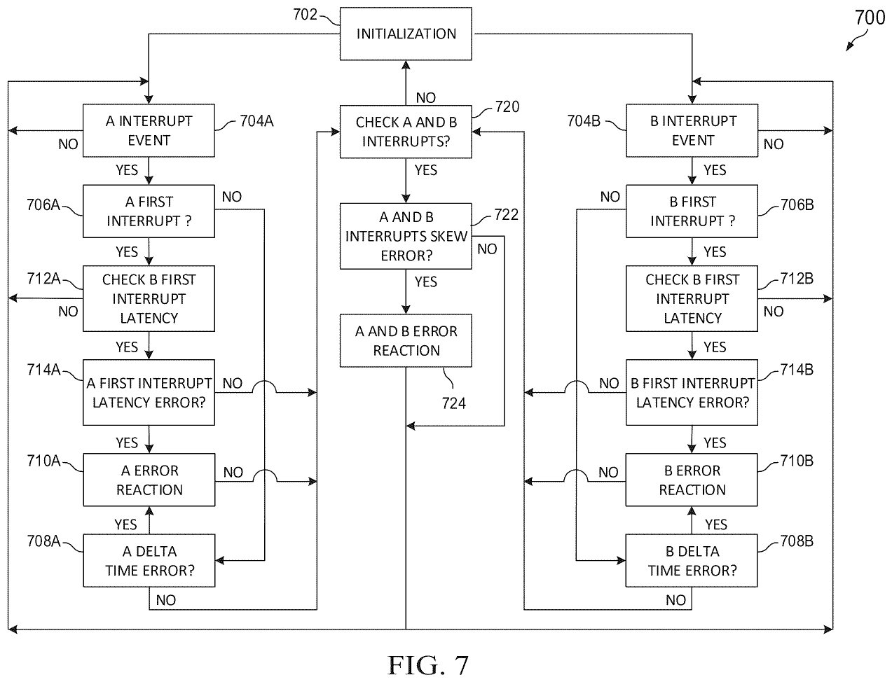

FIG. 7 illustrates a flowchart of an embodiment method 700 for operating circuit 600. Method 700, similar to method 500, can check an elapsed time between (i) two consecutive interrupt events for a synchronous interrupt signal, (ii) activating a function and an associated interrupt signal for an asynchronous interrupt signal, or both. Method 700 can additionally check the time difference (i.e., skew) between the arrival of pairs of interrupt signals in a duplicated interrupt signal architecture, such as that of the second interrupt signal type 204, the fourth interrupt signal type 208, and the sixth interrupt signal type 212.

It is noted that all steps outlined in the flow chart of the method are not necessarily required and can be optional. Further, changes to the arrangement of the steps, removal of one or more steps and path connections, and addition of steps and path connections are similarly contemplated.

At step 702, circuit 600 is initialized to check independent single interrupt signals (A and B) or pair of duplicate interrupt signals (A and B) for errors. In embodiments, the initialization includes loading configuration and threshold definitions from program registers and control registers of the control and status registers 308 to components of circuit 600.

In embodiments, the initialization includes resetting registers designated to store the timestamp values for the interrupt events to zero, for example. In embodiments, a reset signal is used to reset the first timestamp checker 602, the second timestamp checker 604, coupled interrupt checker 606, and various control and status registers 308 registers. The initialization may also include resetting latches associated with the first timestamp checker 602, the second timestamp checker 604, and the coupled interrupt checker 606.

Steps 704A-714A correspond to the checking of an elapsed time between (i) two consecutive interrupt events for synchronous interrupt signal A, (ii) activating a function and an associated interrupt signal for an asynchronous interrupt signal A, or both. The synchronous interrupt signal A is the interrupt signal at the first input terminal of the first timestamp checker 602.

Steps 704B-714B correspond to the checking of an elapsed time between (i) two consecutive interrupt events for synchronous interrupt signal B, (ii) activating a function and an associated interrupt signal for an asynchronous interrupt signal B, or both. The synchronous interrupt signal A is the interrupt signal at the first input terminal of the first timestamp checker 602.

Steps 704A-714A and 704B-714B are similar to those discussed in method 500, with the caveat that different registers, buffers, and latches are associated with the two different interrupt signals (A and B) and timestamp checkers of circuit 600. Otherwise, method 700, similar to method 500, determines whether interrupt signals A, B, or both are timely or untimely and generates an error flag signal in response to the untimely interrupt signal. Accordingly, for brevity, the steps are not described in detail.

Method 700 includes steps 720, 722, and 724 to check the time difference (i.e., skew) between the arrival of pairs of interrupt signals in a duplicated interrupt signal architecture. In embodiments, a register may indicate to circuit 600 whether to check the time difference between the arrival of A and B interrupt events by linking the first timestamp checker 602 to the second timestamp checker 604 through the coupled interrupt checker 606.

At the end of steps 708A-B, 710A-B, and 714A-B, the method transitions to step 720 in response to not detecting an error. If the two interrupt signals are linked together, the method transitions to step 722. Otherwise, the method transitions to step 704A-B to check for errors in subsequent trigger events.

At step 722, the time difference (i.e., skew, displacement) between linked interrupt signal A and interrupt signal B trigger events are compared to a threshold value stored, for example, in a register of circuit 600. In response to the time difference being outside the threshold value, the method transitions to step 724. Otherwise, no error is detected, and the method transitions to step 704A-B to check for errors in subsequent trigger events.

In embodiments, step 722 is completed in response to the first latch associated with the arrival of the trigger associated with the first interrupt (A) and the second latch associated with the arrival of the trigger associated with the second interrupt (B) are asserted-indicating that both triggers have arrived.

At step 724, the coupled interrupt checker 606 generates an error signal indicating a fault with the skew time of the linked interrupt signals. In embodiments, the method remains at step 724 until the interrupt comparison is disabled for the interrupt signal.

FIG. 8 illustrates an embodiment register interface 800, which may be implemented in the control and status registers 308.

First register 802 may be a time selection register indicating whether the multiplexer 304 selects the global time value from between the free-running counter 306 and the external time base 310. For example, the time selection register may have a value of “0” for the multiplexer 304 to select the free-running counter 306 as an input to the timestamp checker 302. The time selection register may have a value of “1” for the multiplexer 304 to select the external time base 310 as an input to the timestamp checker 302.

Second register 804 may store the global time value from either the free-running counter 306 or the external time base 310.

In embodiments, the first register 802 and second register 804 are common to all timestamp checkers in a circuit with multiple timestamp checkers.

The third register 806 through twelfth register 824 are duplicated for each additional timestamp checker. For example, in a circuit with N number of timestamp checkers, the third register 806 through the twelfth register 824 is duplicated N times, where N is an integer greater than one.

Third register 806 may be an enable register indicating whether the timestamp checker is enabled or disabled. For example, it may have a value of “0” to indicate that it is disabled and a value of “1” to indicate that it is enabled.

Fourth register 808 may be an interrupt-type register indicating whether the interrupt is synchronous or asynchronous. For example, it may have a value of “0” to indicate that the interrupt is synchronous and a value of “1” to indicate that it is asynchronous.

Fifth register 810 may be a link register indicating whether two timestamp checkers are coupled or uncoupled. For example, it may have a value of “0” to indicate that two interrupt signals are uncoupled and a value of “1” to indicate that two are coupled.

Sixth register 812 may be a comparison register indicating whether the interrupt is to be checked for errors. For example, it may have a value of “0” to indicate that the interrupt is not to be checked and a value of “1” to indicate that it is to be checked.

Seventh register 814 may be a latch register indicating whether two consecutive interrupt events occurred at the input of the timestamp checker. For example, it may have a value of “0” to indicate that the second interrupt event has not yet arrived and a value of “1” to indicate that the second interrupt event has arrived.

Eight register 816 may store the timestamp value of the arrival of the first interrupt event. Ninth register 818 may store the timestamp value of the arrival of the second interrupt event. Tenth register 820 may store the threshold value of the timestamp checker for a periodic signal. Eleventh register 822 may store the threshold value of the timestamp checker for the tolerance value given to the threshold value. Twelfth register 824 may store the threshold value for the coupled interrupt checker.

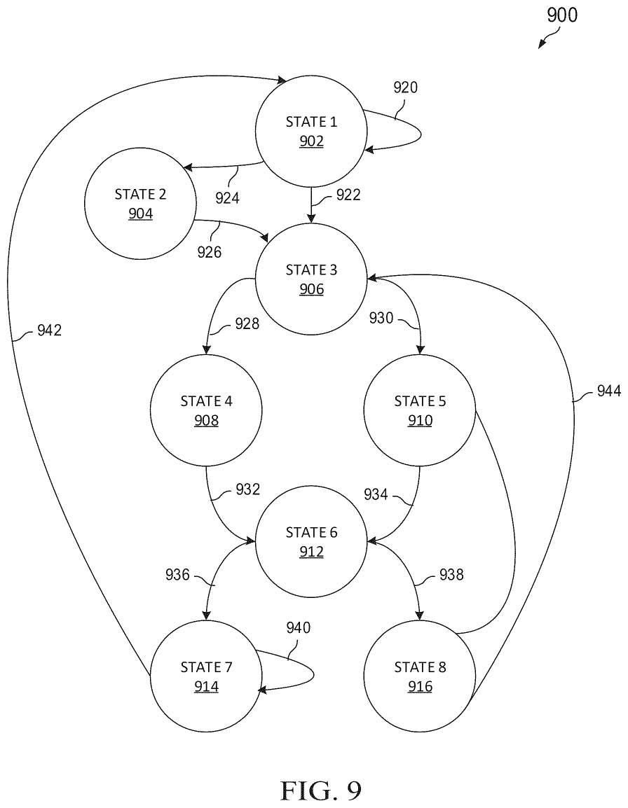

FIG. 9 illustrates a state diagram for a finite state machine (FSM) circuit 900, which may be implemented as the timestamp checker 302 in circuit 300. FSM circuit 900 may operate based on method 500. It should be appreciated that in embodiments, FSM circuit 900 may include different numbers of states and state transitions. For example, FSM circuit 900 may include a reset state before state 902.

State 902 corresponds to the initialization state of the FSM circuit 900. If the timestamp checker is disabled, the FSM circuit remains in state 902 (state transition 920). However, if the timestamp checker is enabled, the registers for the timestamp checker are reset.

The FSM circuit 900 transitions 922 from state 902 to state 904 in response to an asynchronous interrupt signal. The registers for the timestamp checker are set for the asynchronous event, and the timestamp associated with the function's activation is stored in a register. The FSM circuit 900 transitions 926 to state 906.

If the interrupt signal is synchronous, FSM circuit 900 transitions 922 directly from state 902 to state 906. At state 906, the timestamp checker is armed. In embodiments, the timestamp checker is configured via software before being armed at state 906.

When an interrupt trigger arrives at the timestamp checker's input, FSM circuit 900 transitions 928 to state 908 for an asynchronous interrupt; otherwise, it transitions 930 to state 910 for a synchronous interrupt.

At states 908 and 910, the timestamp for the arrival of the interrupt event is stored in a register. After the timestamp is stored, the FSM circuit 900 transitions 932 from state 908 to state 912 for the asynchronous interrupt and transitions 934 from state 910 to state 912 for the synchronous interrupt.

At state 912, for a synchronous interrupt, the absolute value of the timestamp difference between the arrival of the two consecutive timestamps stored in registers is compared to (i) the sum of the threshold value and the tolerance value and (ii) the difference between the threshold value and the tolerance value.

At state 912, for an asynchronous interrupt, the absolute value of the timestamp difference between the functions activation and the arrival of the interrupt event, stored in registers, is compared to (i) the sum of the threshold value and the tolerance value or (ii) the difference between the threshold value and the tolerance value.

If the absolute value of the timestamp difference is greater than the sum of the threshold value and the tolerance value or less than the difference between the threshold value and the tolerance value, the FSM circuit 900 transitions 936 to state 914. Otherwise, the FSM circuit 900 transitions 938 to state 916.

At state 914, FSM circuit 900 generates an error flag indicating that the interrupt signal is not deemed timely. As long as the timestamp checker is enabled, the FSM circuit 900 remains 940 at state 914. If the timestamp checker is disabled, it transitions 942 to state 902.

FSM circuit 900 transitions from state 916 to state 906 for a synchronous signal to verify the next interrupt event.

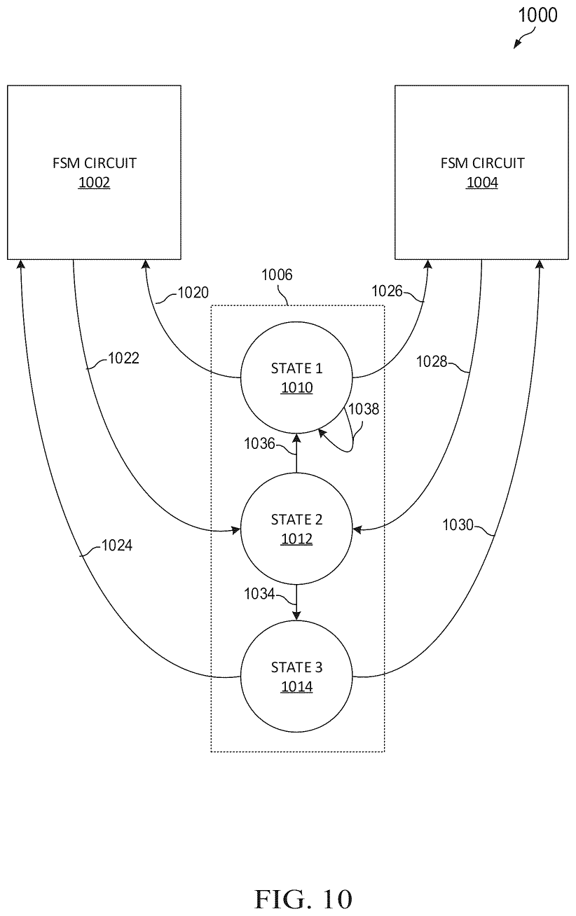

FIG. 10 illustrates a state diagram for a finite state machine circuit (FSM) 1000. FSM circuit 1000 includes a first FSM circuit 1002, a second FSM circuit 1004, and a third FSM circuit 1006, which may be implemented as the first timestamp checker 602, the second timestamp checker 604, and the coupled interrupt checker 606 in circuit 600. FSM circuit 1000 may operate based on method 700. In embodiments, the first FSM circuit 1002, the second FSM circuit 1004, and the third FSM circuit 1006 are a single FSM circuit. It should be appreciated that in embodiments, FSM circuit 1000 may include different numbers of states and state transitions.

The first FSM circuit 1002 and the second FSM circuit 1004 have a structure similar to FSM circuit 900, which allows the first timestamp checker and second timestamp checker to check an elapsed time between (i) two consecutive interrupt events for a synchronous interrupt signal, (ii) activating a function and an associated interrupt signal for an asynchronous interrupt signal, or both. For brevity, the structure and description of operation of the first FSM circuit 1002 and the second FSM circuit 1004 are not repeated.

The third FSM circuit 1006, which is coupled to the first FSM circuit 1002 and the second FSM circuit 1004, additionally allow FSM circuit 1000 to check the time difference (i.e., skew) between the arrival of pairs of interrupt signals in a duplicated interrupt signal architecture, such as that of the second interrupt signal type 204, the fourth interrupt signal type 208, and the sixth interrupt signal type 212.

Once the first FSM circuit 1002 and the second FSM circuit 1004 verify the elapsed time between (i) two consecutive interrupt events for a synchronous interrupt signal, (ii) activating a function and an associated interrupt signal for an asynchronous interrupt signal, or both, FSM circuit 1000 transitions to state 1012.

At state 1012, the time difference (i.e., skew) between the arrival of pairs of interrupt signals in a duplicated interrupt signal architecture are compared against a threshold value. If the comparison indicates an issue with the interrupt signals, the third FSM circuit 1006 transitions to state 1010. Otherwise, the interrupt signals are timely and the third FSM circuit 1006 transitions to state 1014.

At state 1010, the third FSM circuit 1006 generates an error flag indicating that the time difference (i.e., skew) between the arrival of pairs of interrupt signals is outside a threshold value. As long as the timestamp checker is enabled, the third FSM circuit 1006 remains 1038 at state 1010. If the timestamp checker is disabled, it transitions 1020, 1026 to state 902 of the first FSM circuit 1002 and the second FSM circuit 1004.

At state 1014, for a synchronous interrupt, the FSM circuit 1000 transitions to state 906 of the first FSM circuit 1002 and the second FSM circuit 1004 and the process is repeated for subsequent interrupt events.

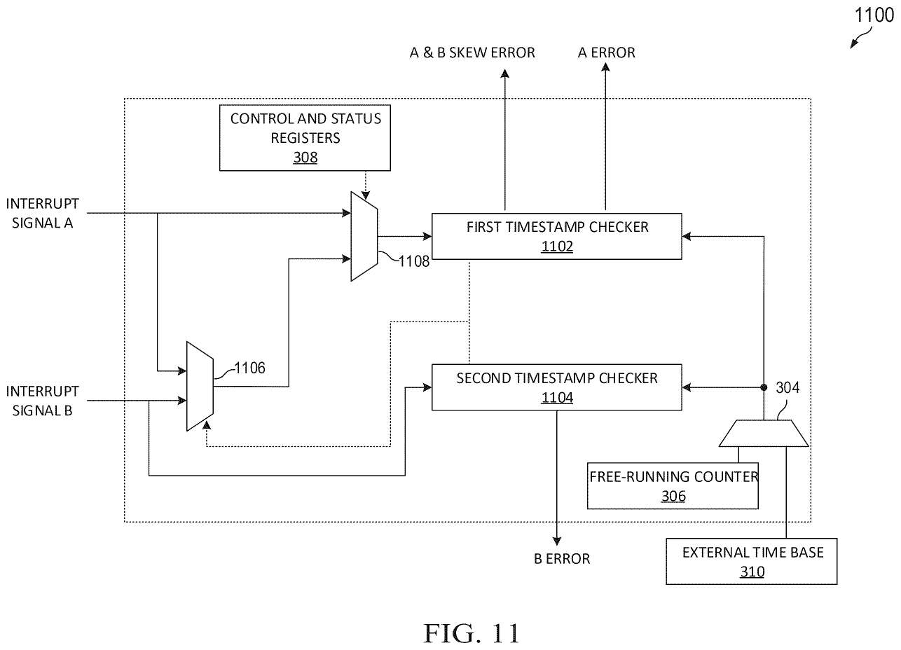

FIG. 11 illustrates a block diagram of an embodiment circuit 1100. Circuit 1100 includes the multiplexer 304, the free-running counter 306, and the control and status registers 308, a first timestamp checker 1102, a second timestamp checker 1104, a second multiplexer 1106, a third multiplexer 1108, which may (or may not) be arranged as shown. Circuit 1100 may be coupled to the external time base 310. The structure and function of components previously discussed concerning the circuit 300 and the circuit 600 are not repeated for brevity.

Circuit 1100 is a hardware solution for monitoring the elapsed time of a device interrupt, similar to circuit 300. Like circuit 600, it can be extended to monitor a time difference (i.e., skew) between the arrival of pairs of interrupts in a duplicated interrupt signal architecture, such as in the second interrupt signal type 204, the fourth interrupt signal type 208, and the sixth interrupt signal type 212. In embodiments, circuit 1100 verifies the occurrence of interrupt events within an adjustable, set time frame.

Each of the first timestamp checker 1102 and the second timestamp checker 1104 includes a first input terminal configured to receive a respective interrupt trigger. In embodiments, the first timestamp checker 1102 and the second timestamp checker 1104 are finite state machine (FSM) circuits.

When the interrupt signals at the first timestamp checker 1102 and the second timestamp checker 1104 are of the first interrupt signal type 202 or the third interrupt signal type 206, the first timestamp checker 1102 and the second timestamp checker 1104 react similarly to the timestamp checker 302 of circuit 300.

In embodiments, a register is set within the control and status registers 308 to decouple the first timestamp checker 1102 and the second timestamp checker 1104. The third multiplexer 1108, based on the linking register value, forwards the first interrupt signal to the first timestamp checker 1102. Because the second input terminal of the third multiplexer 1108 is not fed to the first timestamp checker 1102, the second multiplexer 1106 is not actively participating in the configuration.

When the interrupt signals at the first timestamp checker 1102 and the second timestamp checker 1104 are of the second interrupt signal type 204, the fourth interrupt signal type 208, or the sixth interrupt signal type 212, the second timestamp checker 1104 reacts similarly to the timestamp checker 302 of circuit 300-the first interrupt signal and the second interrupt signal are interrupt signals of a duplicated safety mechanism.

However, in this configuration, the third multiplexer 1108 is configured to forward the output of the second multiplexer 1106 to the first timestamp checker 1102. The initial selection of the second multiplexer 1106 is to forward the first interrupt signal to the third multiplexer 1108, which is forwarded to the first timestamp checker 1102. Once the interrupt signal is verified, the multiplexer forwards the second interrupt event to the third multiplexer 1108, which is forwarded to the first timestamp checker 1102. First timestamp checker 1102 compares the arrival of the interrupt event from the first interrupt signal with interrupt event from the second interrupt signal to determine the time difference between the two signals.

Accordingly, circuit 1100 may operate similarly to circuits 300 and 600 by setting the appropriate register(s) and identifying whether to monitor two independent interrupt signals or to have the additional feature of comparing the skew between duplicate interrupt signals.

In embodiments, each of the first timestamp checker 1102 and the second timestamp checker 1104 is configured to check an elapsed time between (i) two consecutive interrupt events for a synchronous interrupt signal, (ii) activating a function and an associated interrupt signal for an asynchronous interrupt signal, or both, regardless of whether the two interrupt signals are linked or de-linked.

In embodiments, the first timestamp checker 1102 is configured to compare the time difference (i.e., skew) between the first and second interrupt events against a minimum, maximum, or window threshold. If the time difference is outside the defined parameters, the first timestamp checker 1102 generates an error signal, indicating a fault.

Circuit 1100 can be extended to include multiple instances to verify additional interrupt signals. Each additional instance may be configured independently to monitor a different interrupt signal, whether asynchronous or synchronous. The operation of the additional timestamp checkers is similar to that previously described.

A first aspect relates to an interrupt checker circuit. The interrupt checker circuit includes a timestamp checker circuit having a first input terminal coupled to an interrupt signal, a second input terminal of the timestamp checker circuit configured to receive a global time reference, the timestamp checker circuit configured to record a first timestamp corresponding to a first interrupt event at the first input terminal of the timestamp checker circuit based on the global time reference, record a second timestamp corresponding to a second interrupt event at the first input terminal of the timestamp checker circuit based on the global time reference, and compare a time difference between the second timestamp and the first timestamp to an expected duration and, based thereon, generate an error signal in response to the time difference being outside the expected duration.

In a first implementation form of the interrupt checker circuit, according to the first aspect as such, the interrupt checker circuit further includes a free-running counter circuit configured to generate a first reference timestamp at an output of the free-running counter circuit; and a multiplexer having a first input terminal coupled to the output of the free-running counter circuit, a second input terminal of the multiplexer coupled to an output terminal of an external time base, the external time base configured to provide a second reference timestamp at the output of the external time base, the multiplexer configured to select between the first reference timestamp and the second reference timestamp to forward to the timestamp checker circuit as the global time reference.

In a second implementation form of the interrupt checker circuit, according to the first aspect as such or any preceding implementation form of the first aspect, the timestamp checker circuit is further configured to record a third timestamp corresponding to a third interrupt event at the first input terminal of the timestamp checker circuit based on the global time reference; and compare a second time difference between the third timestamp and the second timestamp to the expected duration and, based thereon, generate a second error signal in response to the second time difference being outside the expected duration.

In a third implementation form of the interrupt checker circuit, according to the first aspect as such or any preceding implementation form of the first aspect, the expected duration includes a tolerance value. The error signal is generated in response to the time difference being outside the tolerance value.

In a fourth implementation form of the interrupt checker circuit, according to the first aspect as such or any preceding implementation form of the first aspect, the interrupt signal is a synchronous interrupt signal. The second interrupt event and the first interrupt event are periodic interrupt events of the synchronous interrupt signal.

In a fifth implementation form of the interrupt checker circuit, according to the first aspect as such or any preceding implementation form of the first aspect, the interrupt signal is an asynchronous interrupt signal. The first interrupt event corresponds to completion of an activation of a function and an interrupt event for the function.

In a sixth implementation form of the interrupt checker circuit, according to the first aspect as such or any preceding implementation form of the first aspect, the interrupt checker circuit further includes a plurality of registers for configuring the timestamp checker circuit and storing the first timestamp and the second timestamp.

A second aspect relates to interrupt checker circuit. The interrupt checker circuit includes a first timestamp checker circuit having a first input terminal coupled to a first interrupt signal, the first timestamp checker circuit configured to determine a first elapsed time between two consecutive interrupt events for the first interrupt signal and generate a first error signal in response to the first elapsed time being outside a first expected duration; and a second timestamp checker circuit having a first input terminal coupled to a second interrupt signal, the second timestamp checker circuit configured to determine a second elapsed time between two consecutive interrupt events for the second interrupt signal and generate a second error signal in response to the second elapsed time being outside a second expected duration.

In a first implementation form of the interrupt checker circuit, according to the second aspect as such, the first interrupt signal and the second interrupt signal are redundant interrupt signals. The interrupt checker circuit further comprises a coupled interrupt checker circuit configured to determine a time difference between an arrival of a first interrupt event of the first interrupt signal and an arrival of a first interrupt event of the second interrupt signal; compare the time difference to a third expected duration; and generate a third error signal in response to the time difference being outside the third expected duration.

In a second implementation form of the interrupt checker circuit, according to the second aspect as such or any preceding implementation form of the second aspect, the interrupt checker circuit further comprises a free-running counter circuit configured to generate a first reference timestamp at an output of the free-running counter circuit; and a multiplexer having a first input terminal coupled to the output of the free-running counter circuit, a second input terminal of the multiplexer coupled to an output terminal of an external time base, the external time base configured to provide a second reference timestamp at the output of the external time base, the multiplexer configured to select between the first reference timestamp and the second reference timestamp to forward to the first timestamp checker circuit and the second timestamp checker circuit as a global time reference to determine the first elapsed time and the second elapsed time.

In a third implementation form of the interrupt checker circuit, according to the second aspect as such or any preceding implementation form of the second aspect, the first expected duration and the second expected duration include a corresponding tolerance value. The first error signal and the second error signal are generated in response to the respective elapsed time being outside the corresponding tolerance value.

In a fourth implementation form of the interrupt checker circuit, according to the second aspect as such or any preceding implementation form of the second aspect, the first interrupt signal is a synchronous interrupt signal. The two consecutive interrupt events are periodic interrupt events of the synchronous interrupt signal.

In a fifth implementation form of the interrupt checker circuit, according to the second aspect as such or any preceding implementation form of the second aspect, the first interrupt signal is an asynchronous interrupt signal. A first interrupt event of the two consecutive interrupt events corresponds to completion of an activation of a function and a second interrupt event of the two consecutive interrupt events correspond to an interrupt event for the function.

In a sixth implementation form of the interrupt checker circuit, according to the second aspect as such or any preceding implementation form of the second aspect, the interrupt checker circuit further includes a plurality of registers for configuring the first timestamp checker circuit and the second timestamp checker circuit.

A third aspect relates to a method of operating an interrupt checker circuit. The method comprising determining, by a first timestamp checker circuit of the interrupt checker circuit, a first elapsed time between two consecutive interrupt events for a first interrupt signal; determining, by a second timestamp checker circuit of the interrupt checker circuit, a second elapsed time between two consecutive interrupt events for a second interrupt signal; generating, by the first timestamp checker circuit, a first error signal in response to the first elapsed time being outside a first expected duration; and generating, by the second timestamp checker circuit, a second error signal in response to the second elapsed time being outside a second expected duration.

In a first implementation form of the method, according to the first aspect as such, the first interrupt signal and the second interrupt signal are redundant interrupt signals, the method further comprising determining, by a coupled interrupt checker circuit of the interrupt checker circuit, a time difference between an arrival of a first interrupt event of the first interrupt signal and an arrival of a first interrupt event of the second interrupt signal; comparing, by the coupled interrupt checker circuit, the time difference to a third expected duration; and generating, by the coupled interrupt checker circuit, a third error signal in response to the time difference being outside the third expected duration.

In a second implementation form of the method, according to the third aspect as such or any preceding implementation form of the third aspect, the method further includes generating, by a free-running counter circuit of the interrupt checker circuit, a first reference timestamp at an output of the free-running counter circuit; and forwarding, by a multiplexer of the interrupt checker circuit, the first reference timestamp or a second reference timestamp as a global time reference for the first timestamp checker circuit and the second timestamp checker circuit to determine the first elapsed time and the second elapsed time, wherein the second reference timestamp is generated externally to the interrupt checker circuit.

In a third implementation form of the method, according to the third aspect as such or any preceding implementation form of the third aspect, the first expected duration and the second expected duration include a corresponding tolerance value. The first error signal and the second error signal are generated in response to the respective elapsed time being outside the corresponding tolerance value.

In a fourth implementation form of the method, according to the third aspect as such or any preceding implementation form of the third aspect, the first interrupt signal is a synchronous interrupt signal. The two consecutive interrupt events are periodic interrupt events of the synchronous interrupt signal.

In a fifth implementation form of the method, according to the third aspect as such or any preceding implementation form of the third aspect, the first interrupt signal is an asynchronous interrupt signal. A first interrupt event of the two consecutive interrupt events corresponds to completion of an activation of a function and a second interrupt event of the two consecutive interrupt events correspond to an interrupt event for the function.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. An interrupt checker circuit, comprising:
a timestamp checker circuit having a first input terminal coupled to an interrupt signal, a second input terminal of the timestamp checker circuit configured to receive a global time reference, the timestamp checker circuit configured to:
record a first timestamp corresponding to a first interrupt event at the first input terminal of the timestamp checker circuit based on the global time reference,
record a second timestamp corresponding to a second interrupt event at the first input terminal of the timestamp checker circuit based on the global time reference, and
compare a time difference between the second timestamp and the first timestamp to an expected duration and, based thereon, generate an error signal in response to the time difference being outside the expected duration.

2. The interrupt checker circuit of claim 1, further comprising:
a free-running counter circuit configured to generate a first reference timestamp at an output of the free-running counter circuit; and
a multiplexer having a first input terminal coupled to the output of the free-running counter circuit, a second input terminal of the multiplexer coupled to an output terminal of an external time base, the external time base configured to provide a second reference timestamp at the output of the external time base, the multiplexer configured to select between the first reference timestamp and the second reference timestamp to forward to the timestamp checker circuit as the global time reference.

3. The interrupt checker circuit of claim 1, wherein the timestamp checker circuit is further configured to:
record a third timestamp corresponding to a third interrupt event at the first input terminal of the timestamp checker circuit based on the global time reference; and
compare a second time difference between the third timestamp and the second timestamp to the expected duration and, based thereon, generate a second error signal in response to the second time difference being outside the expected duration.

4. The interrupt checker circuit of claim 1, wherein the expected duration includes a tolerance value, and wherein the error signal is generated in response to the time difference being outside the tolerance value.

5. The interrupt checker circuit of claim 1, wherein the interrupt signal is a synchronous interrupt signal, and wherein the second interrupt event and the first interrupt event are periodic interrupt events of the synchronous interrupt signal.

6. The interrupt checker circuit of claim 1, wherein the interrupt signal is an asynchronous interrupt signal, and wherein the first interrupt event corresponds to completion of an activation of a function and an interrupt event for the function.

7. The interrupt checker circuit of claim 1, further comprising a plurality of registers for configuring the timestamp checker circuit and storing the first timestamp and the second timestamp.

8. An interrupt checker circuit, comprising:
a first timestamp checker circuit having a first input terminal coupled to a first interrupt signal, the first timestamp checker circuit configured to determine a first elapsed time between two consecutive interrupt events for the first interrupt signal and generate a first error signal in response to the first elapsed time being outside a first expected duration; and
a second timestamp checker circuit having a first input terminal coupled to a second interrupt signal, the second timestamp checker circuit configured to determine a second elapsed time between two consecutive interrupt events for the second interrupt signal and generate a second error signal in response to the second elapsed time being outside a second expected duration.

9. The interrupt checker circuit of claim 8, wherein the first interrupt signal and the second interrupt signal are redundant interrupt signals, wherein the interrupt checker circuit further comprises a coupled interrupt checker circuit configured to:
determine a time difference between an arrival of a first interrupt event of the first interrupt signal and an arrival of a first interrupt event of the second interrupt signal;
compare the time difference to a third expected duration; and
generate a third error signal in response to the time difference being outside the third expected duration.

10. The interrupt checker circuit of claim 8, further comprising
a free-running counter circuit configured to generate a first reference timestamp at an output of the free-running counter circuit; and
a multiplexer having a first input terminal coupled to the output of the free-running counter circuit, a second input terminal of the multiplexer coupled to an output terminal of an external time base, the external time base configured to provide a second reference timestamp at the output of the external time base, the multiplexer configured to select between the first reference timestamp and the second reference timestamp to forward to the first timestamp checker circuit and the second timestamp checker circuit as a global time reference to determine the first elapsed time and the second elapsed time.

11. The interrupt checker circuit of claim 8, wherein the first expected duration and the second expected duration include a corresponding tolerance value, and wherein the first error signal and the second error signal are generated in response to the respective elapsed time being outside the corresponding tolerance value.

12. The interrupt checker circuit of claim 8, wherein the first interrupt signal is a synchronous interrupt signal, and wherein the two consecutive interrupt events are periodic interrupt events of the synchronous interrupt signal.

13. The interrupt checker circuit of claim 8, wherein the first interrupt signal is an asynchronous interrupt signal, and wherein a first interrupt event of the two consecutive interrupt events corresponds to completion of an activation of a function and a second interrupt event of the two consecutive interrupt events correspond to an interrupt event for the function.

14. The interrupt checker circuit of claim 8, further comprising a plurality of registers for configuring the first timestamp checker circuit and the second timestamp checker circuit.

15. A method of operating an interrupt checker circuit, the method comprising:
determining, by a first timestamp checker circuit of the interrupt checker circuit, a first elapsed time between two consecutive interrupt events for a first interrupt signal;
determining, by a second timestamp checker circuit of the interrupt checker circuit, a second elapsed time between two consecutive interrupt events for a second interrupt signal;
generating, by the first timestamp checker circuit, a first error signal in response to the first elapsed time being outside a first expected duration; and
generating, by the second timestamp checker circuit, a second error signal in response to the second elapsed time being outside a second expected duration.

16. The method of claim 15, wherein the first interrupt signal and the second interrupt signal are redundant interrupt signals, the method further comprising:
determining, by a coupled interrupt checker circuit of the interrupt checker circuit, a time difference between an arrival of a first interrupt event of the first interrupt signal and an arrival of a first interrupt event of the second interrupt signal;
comparing, by the coupled interrupt checker circuit, the time difference to a third expected duration; and
generating, by the coupled interrupt checker circuit, a third error signal in response to the time difference being outside the third expected duration.

17. The method of claim 15, further comprising:
generating, by a free-running counter circuit of the interrupt checker circuit, a first reference timestamp at an output of the free-running counter circuit; and
forwarding, by a multiplexer of the interrupt checker circuit, the first reference timestamp or a second reference timestamp as a global time reference for the first timestamp checker circuit and the second timestamp checker circuit to determine the first elapsed time and the second elapsed time, wherein the second reference timestamp is generated externally to the interrupt checker circuit.

18. The method of claim 15, wherein the first expected duration and the second expected duration include a corresponding tolerance value, and wherein the first error signal and the second error signal are generated in response to the respective elapsed time being outside the corresponding tolerance value.

19. The method of claim 15, wherein the first interrupt signal is a synchronous interrupt signal, and wherein the two consecutive interrupt events are periodic interrupt events of the synchronous interrupt signal.

20. The method of claim 15, wherein the first interrupt signal is an asynchronous interrupt signal, and wherein a first interrupt event of the two consecutive interrupt events corresponds to completion of an activation of a function and a second interrupt event of the two consecutive interrupt events correspond to an interrupt event for the function.
